(19) United States
(12) Patent Application Publication
(10) Pub. No.: US 2010/0092744 A1
(43) Pub. Date: Apr. 15, 2010

(54) Automotive headliner composite structure

(75) Inventors: Ranganathan Soundararajan, Simpsonville, SC (US); Anthony Verrocchi, Greer, SC (US)

Correspondence Address: Sealed Air Corporation, P.O. Box 464, Duncan, SC, 29334, US

(73) Assignee: Cryovac, Inc.

(21) Appl. No.: 12/287,459

(22) Filed: Oct. 9, 2008

(51) Int. Cl. B60R 13/02

(52) U.S. Cl. 428/213

(57) ABSTRACT

A composite structure comprises a first substrate, a film, and a second substrate. The film comprises a first outer layer, a second outer layer, and an intermediate layer between the first and second outer layers. The first substrate comprises one or more polymers selected from polyurethane and polyester and is adhered to the first outer layer of the film. The second substrate is adhered to the second outer layer of the film. The first outer layer of the film comprises ionomer. The second outer layer of the film comprises one or more polymers selected from a) ionomer, b) polyamide having a melting point of at most about 200° C., c) amorphous polyamide, and d) polyester. The intermediate layer comprises one or more polyamides. The composite structure may be, for example, an automotive headliner assembly.

### BACKGROUND

The present invention relates to a composite structure, for example, an automotive headliner assembly comprising a film.

Vehicle trim panels, for example, automotive headliners, may be formed by a “wet style” of manufacture generally in which layers of polyurethane foam and glass goods are adhered with a liquid adhesive, such as a liquid isocyanate-based adhesive, that is subsequently cured while the panel is pressed together under heat to a desired shape and contour. Fabric may be applied at the surface of the headliner facing the interior of the passenger compartment. Examples of automotive headliners are disclosed in U.S. Pat. Nos. 5,460,870; 5,486,256; 5,582,906; and 5,670,211, each of which is incorporated herein in its entirety by reference.

The panel may thus comprise thermosetting adhesive, such as an isocyanate-based polyurethane adhesive, to adhere two or more internal layers of the panel to each other. Such adhesive is applied in a liquid state and subsequently cured during formation of the panel. However, before or even after curing the adhesive, unreacted or partially reacted components may migrate or “bleed” through the component layers of the panel to present an undesirable effect on the surface of the panel.

There are several films available from Dow Chemical Company under the INTEGRAL trade name, and also under the DAF 780 and XU 66129.00 trade names. These films are believed to have been used to adhere first and second substrates together in the formation of composite structures, for example, formed by the “wet style” of manufacture. These films are believed generally to comprise a core layer of polyolefin (e.g., polyethylene copolymer or polypropylene) and an outer layer of ethylene/acrylic acid copolymer.

The panel may be contoured to accommodate the functional and styling needs of the interior of a passenger compartment of an automobile. Such contours may be formed by molding the materials of the panel assembly under heat and pressure between complimentary male and female molds having a desired shape and contour. Contoured regions of a shaped panel assembly may present the problem of inadequate adhesion of the component parts of the assembly in the contoured regions.

There also exists on occasion problems associated with glass goods, such as chopped glass, that as a component portion of a panel protrude from the interior of the panel to cause an undesirable rippled or “orange peel” visual effect on the surface of the panel.

It is also known to use a “dry style” of manufacturing to form an automotive headliner composite structure. Existing films have been used in conjunction with the dry style to adhere, for example, a glass mat thermoplastic (GMT) to a coverstock. Such films include those from Sealed Air Corporation under the TSM 2418 and the RDL 831 trade names, and from Collano Xiro AG under the XAF 45.311, XAF 45.301, and XAF 45.300 trade names. These Collano Xiro films are believed to comprise a base film of ethylene/propylene copolymer that is extrusion coated with a layer of co-polyamide on the surface.

### SUMMARY

One or more embodiments of the present invention may addresses one or more of the aforementioned problems.

A composite structure comprises a film comprising a first outer layer, a second outer layer, and an intermediate layer between the first and second outer layers. The first outer layer comprises ionomer. The second outer layer comprises one or more polymers selected from a) ionomer, b) polyamide having a melting point of at most about 200° C., c) amorphous polyamide, and d) polyester. The intermediate layer comprises one or more polyamides. A first substrate is adhered to the first outer layer of the film. The first substrate comprises a primary layer having a thickness greater than the thickness of the film. The first substrate comprises one or more polymers selected from polyurethane and polyester. A second substrate is adhered to the second outer layer of the film. The second substrate has a thickness greater than the thickness of the film.

The composite structure may be, for example, a vehicle trim panel assembly.

These and other objects, advantages, and features of the invention will be more readily understood and appreciated by reference to the detailed description and the drawings.

### BRIEF DESCRIPTION OF THE DRAWINGS

FIG. 1 is a representative schematic cross-section of an embodiment 30 of the composite structure.

FIG. 2 is a representative schematic cross-section of an embodiment 30′ of the composite structure.

FIG. 3 is a representative schematic cross-section of an embodiment 30″ of the composite structure.

FIG. 4 is a representative schematic cross-section of an embodiment 10′ of the film.

FIG. 5a is a representative schematic side-view of creep testing at the interface between the film 10 and the second substrate 20.

FIG. 5b is a representative schematic side-view of creep testing at the interface between the first substrate 18 and the film 10.

FIG. 6 is a representative schematic perspective view of a composite structure having a contoured region.

FIG. 7 is a representative schematic cross-section of a press forming mold in the open position.

FIG. 8 is a representative schematic cross-section of a press forming mold in the closed position.

Various aspects of the subject matter disclosed herein are described with reference to the drawings. For purposes of simplicity, like numerals may be used to refer to like, similar, or corresponding elements of the various drawings. The drawings and detailed description are not intended to limit the claimed subject matter to the particular form disclosed. Rather, the intention is to cover all modifications, equivalents, and alternatives falling within the spirit and scope of the claimed subject matter.

### DETAILED DESCRIPTION

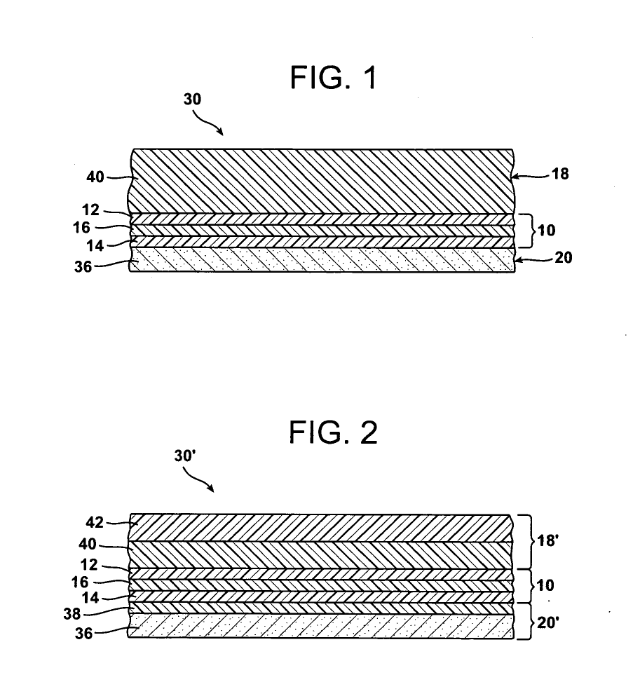

Embodiments of the invention are shown as composite structures 30, 30′, and 30″, which include film 10 adhering a first substrate 18, 18′, 18″ to a second substrate 20, 20′, and 20″, respectively. (FIGS. 1-3.) The composite structure may be formed in a mold to a desired shape under heat and pressure (e.g., compression molding), as discussed in more detail below.

### Film

Films 10, 10′ comprises first outer layer 12, second outer layer 14, and intermediate layer 16. (FIGS. 1-4.) The intermediate layer 16 is between the first and second outer layers 12, 14. Thus, the intermediate layer 16 is an internal layer of the film between the first and second outer layers of the film. The intermediate layer 16 may be directly adjacent the first and/or second outer layers, meaning that there is no intervening layer between the intermediate layer and one or both of the outer layers, as illustrated in FIGS. 1-3 with respect to film 10. Alternatively, and as illustrated in FIG. 4 with respect to film 10′, one or more intervening internal layers (e.g., tie layers, discussed below) may exist between intermediate layer 16 and the outer layers, in which case the intermediate layer 16 is spaced apart from an outer layer so that the intermediate layer is not directly adjacent the outer layer.

The film may comprise at least any of the following numbers of layers: 3, 4, 5, 7, 9; and may comprise at most any of the following numbers of layers: 4, 5, 6, 7, 8, 9, 11, 13, and 15. The term “layer” refers to a discrete film component which is substantially coextensive with the film and has a substantially uniform composition. Where two or more directly adjacent layers have essentially the same composition, then these two or more adjacent layers may be considered a single layer for the purposes of this application.

The film may have a total thickness of at least about, and/or at most about, any of the following: 1, 2, 3, 4, 5, 7, 9, 10, 12, and 15 mils.

The first and second outer layers 12, 14 are outer layers of the films 10, 10′. An “outer layer” of the film is a layer that has only one side directly adjacent to another layer of the film. For multilayered films, there inherently exists two outer layers of the film.

### First Outer Layer of the Film

In one or more embodiments of the invention, the first outer layer 12 of films 10, 10′ comprises ionomer. Ionomer is a copolymer of ethylene and an ethylenically unsaturated monocarboxylic acid having the carboxylic acid groups partially neutralized by a metal ion, for example, sodium or zinc. Useful ionomers include those in which sufficient metal ion is present to neutralize from about 10% to about 60% of the acid groups in the ionomer. The carboxylic acid is preferably “(meth)acrylic acid”—which means acrylic acid and/or methacrylic acid. Useful ionomers include those having at least about any of 50%, 60%, and 80 weight % ethylene units. Useful ionomers also include those having from 1 to 20 weight percent acid units. Useful ionomers are available, for example, from Dupont Corporation (Wilmington, Del.) under the SURLYN trademark. Useful ionomers are those having a melting temperature, for example, of at least about, and/or at most about, any of the following: 80, 85, 90, 95, 100, 105, and 110° C.

First outer layer 12 may comprise ionomer, or any type of ionomer described herein, in at least about, and/or at most about, any of the following amounts: 40, 50, 60, 70, 80, 90, 95, and 100%, by weight of the layer.

### Second Outer Layer of the Film

The second outer layer 14 of films 10, 10′ may have the same composition as first outer layer 12; or the second outer layer 14 may have a different composition that that of first outer layer 12. The second outer layer 14 may have approximately the same thickness as first outer layer 12; or the second outer layer 14 may have an essentially different thickness from first outer layer 12.

The second outer layer 14 may comprise one or more polymers selected from a) ionomer, b) polyamide having a melting point of at most about 200° C., c) amorphous polyamide, and d) polyester.

The second outer layer 14 may comprise ionomer, or any one type of ionomer described in this Application, in at least about, and/or at most about, any of the following amounts: 40, 50, 60, 70, 80, 90, 95, and 100%, by weight of the layer. The second outer layer may comprise ionomer that is the same as that of the first outer layer, and/or the second outer layer may comprise ionomer that is different from the ionomer comprised by the first outer layer.

The second outer layer 14 may comprise one or more polyamides having a melting point of at most about 200° C., or any one polyamide described in this Application that have a melting point of at most about 200° C., in at least about, and/or at most about, any of the following amounts: 40, 50, 60, 70, 80, 90, 95, and 100%, by weight of the layer. Representative polyamides that may have a melting point of at most about 200° C. include, for example, nylon-6/12, nylon-12, nylon-12,T, nylon-6/6,9, nylon-11, nylon-12, and nylon-6,6,/6,10 (having from about 10% to about 60% nylon-6,6 in the copolymer).

The second outer layer 14 may comprise one or more amorphous polyamides, or any one amorphous polyamide described in this Application, in at least about, and/or at most about, any of the following amounts: 40, 50, 60, 70, 80, 90, 95, and 100%, by weight of the layer. Representative amorphous polyamide includes, for example, nylon-6,I/6,T.

The second outer layer 14 may comprise one or more polyesters, or any one polyester described in this Application, in at least about, and/or at most about, any of the following amounts: 40, 50, 60, 70, 80, 90, 95, and 100%, by weight of the layer. Representative polyesters include, for example, polyester thermoplastic elastomers, such as those available from Dupont Corporation under the HYTREL trade name.

The second outer layer 14 may have a melting point of at most about, and/or at least about, any of the following: 200, 190, 180, 170, 160, 150, and 140° C.

All references to the melting point of a polymer, a resin, or a film layer in this Application refer to the melting peak temperature of the dominant melting phase of the polymer, resin, or layer as determined by differential scanning calorimetry according to ASTM D-3418.

An amorphous polymer, for example an amorphous polyamide, is a polymer that does not clearly display a melting point. Useful amorphous polyamide may have a glass transition temperature of at most about, and/or at least about, any of the following values: 125° C., 120° C., 110° C., 100° C., 90° C., 80° C., 70° C., 60° C., and 50° C. All references to the glass transition temperature of a polymer, a resin, or a film layer in this application refer to the characteristic temperature at which glassy or amorphous polymers become flexible as determined by differential scanning calorimetry (DSC) according to ASTM D-3417, measured where the relative humidity is 50%.

Useful polyesters include those made by: 1) condensation of polyfunctional carboxylic acids with polyfunctional alcohols, 2) polycondensation of hydroxycarboxylic acid, and 3) polymerization of cyclic esters (e.g., lactone).

Exemplary polyfunctional carboxylic acids (and their derivatives) include aromatic dicarboxylic acids and derivatives (e.g., terephthalic acid, isophthalic acid, dimethyl terephthalate, dimethyl isophthalate) and aliphatic dicarboxylic acids and derivatives (e.g., adipic acid, azelaic acid, sebacic acid, oxalic acid, succinic acid, glutaric acid, dodecanoic diacid, 1,4-cyclohexane dicarboxylic acid, dimethyl-1,4-cyclohexane dicarboxylate ester, dimethyl adipate). Useful dicarboxylic acids also include those discussed above in associate with polyamides.

Exemplary polyfunctional alcohols include dihydric alcohols (and bisphenols) such as ethylene glycol, 1,2-propanediol, 1,3-propanediol, 1,3 butanediol, 1,4-butanediol, 1,4-cyclohexanedimethanol, 2,2-dimethyl-1,3-propanediol, 1,6-hexanediol, poly(tetrahydroxy-1,1′-biphenyl, and 1,4-hydroquinone.

Exemplary hydroxycarboxylic acids and lactones include 4-hydroxybenzoic acid, 6-hydroxy-2-naphthoic acid, pivalolactone, and caprolactone.

Useful polyesters include homopolymers and copolymers. These may be derived from one or more of the constituents discussed above. Exemplary polyesters include poly(ethylene terephthalate) (“PET”), poly(butylene terephthalate) (“PBT”), and poly(ethylene naphthalate) (“PEN”). If the polyester includes a mer unit derived from terephthalic acid, then such mer content (mole %) of the polyester may be at least about any the following: 70, 75, 80, 85, 90, and 95%.

The polyester may be thermoplastic. The polyester (e.g., copolyester) may be amorphous, or alternatively may have a melting point. As mentioned above, the polyester may comprise polyester thermoplastic elastomer. Useful polyester thermoplastic elastomers may be those prepared using terephthalic acids or esters, polyalkylene ether glycols (e.g., poly(tetramethylene ether) glycol), and lower alkyl diols (e.g., 1,4-butanediol). By way of example, the elastomer chain of the polyester thermoplastic elastomer may have two types of recurring units, one type comprising the terephthalic acid and the glycol, and the other type comprising the terephthalic acid and the diol.

### Intermediate Layer of the Film

The intermediate layer 16 of films 10, 10′ is between the first and second outer layers. The intermediate layer may comprise polyamide, for example, may comprise polyamide selected from one or more of nylon-6 and nylon-6/6,6.

The intermediate layer may have a melting point greater than the melting point of the first and/or second outer layers. The intermediate layer may have a melting point of at least about, and/or at most about, any of the following: 190° C., 200° C., 210° C., 220° C., 230° C., and 240° C. The intermediate layer may comprising one or more polyamides having a melting point of at least about, and/or at most about, any of the following: 190° C., 200° C., 210° C., 220° C., 230° C., and 240° C.

Useful polyamides include those of the type that may be formed by the polycondensation of one or more diamines with one or more diacids and/or of the type that may be formed by the polycondensation of one or more amino acids (including those provided by the ring opening polymerization of lactams). Useful polyamides include aliphatic polyamides and aliphatic/aromatic polyamides.

Representative polyamides of the type that may be formed by the polycondensation of one or more diamines with one or more diacids include aliphatic polyamides such as poly(hexamethylene adipamide) (“nylon-6,6”), poly(hexamethylene sebacamide) (“nylon-6,10”), poly(heptamethylene pimelamide) (“nylon-7,7”), poly(octamethylene suberamide) (“nylon-8,8”), poly(hexamethylene azelamide) (“nylon-6,9”), poly(nonamethylene azelamide) (“nylon-9,9”), poly(decamethylene azelamide) (“nylon-10,9”), poly(tetramethylenediamine-co-oxalic acid) (“nylon-4,2”), the polyamide of n-dodecanedioic acid and hexamethylenediamine (“nylon-6,12”), the polyamide of dodecamethylenediamine and n-dodecanedioic acid (“nylon-12,12”).

Representative aliphatic/aromatic polyamides include poly(tetramethylenediamine-co-isophthalic acid) (“nylon-4,I”), polyhexamethylene isophthalamide (“nylon-6,I”), polyhexamethylene terephthalamide (“nylon-6,T”), poly (2,2,2-trimethyl hexamethylene terephthalamide), poly(m-xylylene adipamide) (“nylon-MXD,6”), poly(p-xylylene adipamide), poly(hexamethylene terephthalamide), poly(dodecamethylene terephthalamide), and polyamide-MXD,I.

Representative polyamides of the type that may be formed by the polycondensation of one or more amino acids (including the ring opening of lactams) include poly(4-aminobutyric acid) (“nylon-4”), poly(6-aminohexanoic acid) (“nylon-6” or “poly(caprolactam)”), poly(7-aminoheptanoic acid) (“nylon-7”), poly(8-aminooctanoic acid) (“nylon-8”), poly(9-aminononanoic acid) (“nylon-9”), poly(10-aminodecanoic acid) (“nylon-10”), poly(11-aminoundecanoic acid) (“nylon-11”), and poly(12-aminododecanoic acid) (“nylon-12”).

Representative copolyamides include copolymers based on a combination of the monomers used to make any of the foregoing polyamides, such as, nylon-4/6, nylon-6/6, nylon-6/9, nylon-6/12, caprolactam/hexamethylene adipamide copolymer (“nylon-6,6/6”), hexamethylene adipamide/caprolactam copolymer (“nylon-6/6,6”), trimethylene adipamide/hexamethylene azelaiamide copolymer (“nylon-trimethyl 6,2/6,2”), hexamethylene adipamide-hexamethylene-azelaiamide caprolactam copolymer (“nylon-6,6/6,9/6”), hexamethylene adipamide/hexamethylene-isophthalamide (“nylon-6,6/6,I”), hexamethylene adipamide/hexamethyleneterephthalamide (“nylon-6,6/6,T”), nylon-6,T/6,I, nylon-6/MXD,T/MXD,I, nylon-6,6/6,10, and nylon-6,I/6,T.

The intermediate layer 16 may comprise polyamide, or any type of polyamide described herein, in at least about, and/or at most about, any of the following amounts: 40, 50, 60, 70, 80, 90, 95, and 100%, by weight of the layer.

### Tie Layers of the Film

The film may comprise one or more tie layers. A tie layer is a layer that has two adjacent layers on either side, and has a primary function of improving the adherence of the adjacent layers to each other. For example, film 10′ includes upper tie layer 32 between the first outer layer 12 and the intermediate layer 16. (FIG. 4.) Also by way of example, film 10′ includes lower tie layer 34 between second outer layer 14 and the intermediate layer 16. (FIG. 4.)

A tie layer may comprise one or more polymers having grafted polar groups so that the polymer is capable of enhanced bonding to polar polymers, for example, ionomer and polyamide. Useful polymers for tie layers include ethylene/unsaturated acid copolymer, ethylene/unsaturated ester copolymer, anhydride-modified polyolefin, polyurethane, polyamide, and mixtures thereof. Further exemplary polymers for tie layers include ethylene/vinyl acetate copolymer having a vinyl acetate content of at least about, and/or at most about, any of the following: 3, 6, 15, 20, 25, and 30 weight %; ethylene/methyl acrylate copolymer having a methyl acrylate content of at least about 20 weight %; anhydride-modified ethylene/methyl acrylate copolymer having a methyl acrylate content of at least about any of the following: 5, 10, 15, and 20 weight %; and anhydride-modified ethylene/alpha-olefin copolymer, such as an anhydride grafted LLDPE. A tie layer may comprise one or more of any the polymers described in this paragraph in at least about, and/or at most about, any of the following amounts based on the weight of the tie layer: 20, 30, 40, 50, 60, 70, 80, 90, 95, and 100%. For example, a tie layer may comprise at least about 30% and at most about 80% of anhydride-modified polyolefin (e.g., anhydride modified LLDPE) and at least about 20% and at most about 70% ethylene/vinyl acetate copolymer.

Modified polymers or anhydride-modified polymers include polymers prepared by copolymerizing an unsaturated carboxylic acid (e.g., maleic acid, fumaric acid), or a derivative such as the anhydride, ester, or metal salt of the unsaturated carboxylic acid with—or otherwise incorporating the same into—an olefin homopolymer or copolymer. Thus, anhydride-modified polymers have an anhydride functionality achieved by grafting or copolymerization.

### Film Layer Thicknesses

Any one of the layers of the film may have a thickness of at least about, and/or at most about, any of the following: 0.05, 0.1, 0.5, 1, 1.3, 1.5, 2, 2.5, 3, 4, 5, and 6 mils. Any one of the layers of the film may have a thickness as a percentage of the total thickness of the film of at least about, and/or at most about, any of the following: 1, 3, 5, 7, 10, 13, 15, 20, 25, 30, 35, 40, 45, and 50 percent. For example, the intermediate layer of the film may have a thickness as a percentage of the total thickness of the film of at most about 15% or at most about 10%.

### First Substrate of the Composite Structure

The film 10, 10′ may be adhered to first substrate 18, 18′, 18″, for example, by having the first substrate adhered to the first outer layer 12 of film 10, 10′. For example, first outer layer 12 may be directly adjacent to first substrate 18, 18′, 18″ of the composite structure.

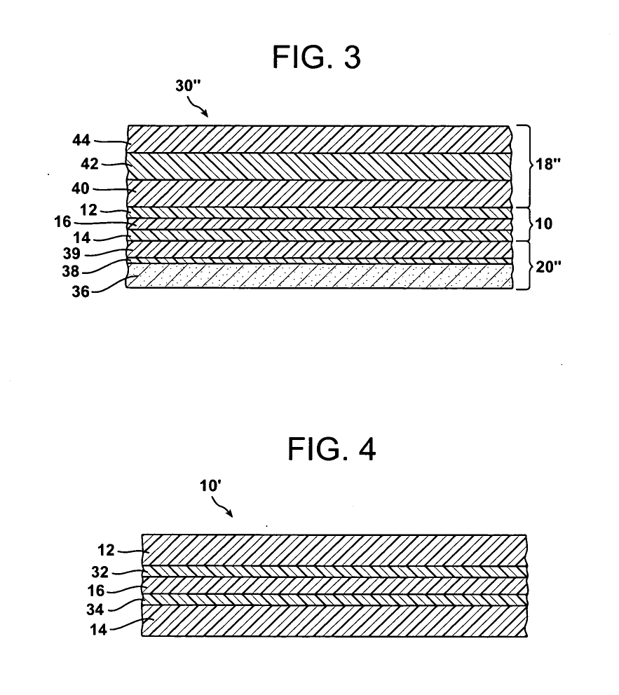

The first substrate may comprise only one layer, for example, first substrate 18 comprises primary layer 40 (FIG. 1). The first substrate may comprise only two layers, for example, first substrate 18′ comprises primary layer 40 and supplemental layer 42 (FIG. 2). The first substrate may comprise three or more layers, for example, first substrate 18″ comprises primary layer 40, supplemental layer 42, and one or more additional layers 44 (FIG. 3).

The first outer layer 12 of film 10 may be adhered to the primary layer 40 and also be directly adjacent the primary layer 40 of the first substrate 18, 18′, 18″. (FIGS. 1-3.) Alternatively, the first outer layer of the film may be adhered to the primary layer of the first substrate and not be directly adjacent the primary layer of the first substrate, for example, by having a supplemental layer or one or more additional layers between the first outer layer of the film and the primary layer of the first substrate. (Not illustrated.)

The primary layer of the first substrate may comprise one or more polymers selected from polyurethane and polyester. The primary layer may comprise polyurethane and/or polyester in least about, and/or at most about, any of the following amounts: 40, 50, 60, 70, 80, 90, 95, and 100%, by weight of the layer.

The polyurethane may be foamed (i.e., cellular). Thus, the primary layer of the first substrate may comprise foamed plastic comprising polyurethane. For example, the foam of the primary layer may have a density of at least about, and/or at most about, any of the following: 1, 2, and 3 pounds per cubic foot. Alternatively, the polyurethane may be non-foamed (i.e., non-cellular). Thus, the primary layer of the first substrate may comprise non-foamed polyurethane. The non-foamed polyurethane may comprise one or more dehydrating agents (e.g., zeolite filler), as is known in the art.

Any of the first substrate, the primary layer 40, the supplemental layer 42, and the one or more additional layers 44 of the first substrate may comprise one or more reinforced plastics. A reinforced plastic comprises one or more plastic resin materials forming a matrix in which one or more reinforcement materials are embedded. For example, the primary layer may comprise polyurethane and/or polyester reinforced by one or more reinforcement materials described herein.

The reinforced plastic may comprise one or more plastic resin materials selected from:

1) thermoplastic resin, for example, one or more of any of the following: polyolefin (e.g., polypropylene, polyethylene), polyester (e.g., polyethylene terephthalate (PET) and polybutylene terephthalate (PBT)), polyamide, polyphenylene ether (PPE), polyetherimide (PEI), polyketones (e.g., polyetheretherketone (PEEK)), and styrenic resin; and

2) thermosetting resin, for example, one or more of any of the following: polyester, polyurethane, melamine resin, and phenol resin.

The reinforced plastic may comprise reinforcement material comprising one or more materials selected from: glass, aramid, carbon, polyester, polyolefin (e.g., polyethylene), and nylon.

The reinforcement material may take the form of any of flakes, spheres, and fibers, for example, chopped strand, continuous strand, mat, woven roving, woven fabrics, non-woven fabrics, and milled fibers.

Any of first substrate, the primary layer 40, the supplemental layer 42, and the one or more additional layers 44, may comprise reinforced plastic (e.g., any of the reinforced plastics described herein) in at least about, and/or at most about, any of the following amounts: 50, 70, 90, and 99%, based on the weight of the first substrate, the primary layer, the supplemental layer, and the one or more additional layers, respectively.

Any of the first substrate, the primary layer 40, the supplemental layer 42, and the one or more additional layers 44, may comprise foamed plastic (i.e., cellular plastic). The foamed plastic may comprise, for example, one or more polymers selected from polyurethane, polyphenylene oxide (PPO), polyether, polyetherimide (PEI), polyolefin (e.g., polypropylene, polyethylene), polystyrene, (e.g., styrene-maleic anhydride (SMA)), polyester, and polyamide. The foamed plastic may comprise any one or combination of these polymers in at least about, and/or at most about, any of 50, 70, 90, and 99%, based on the weight of the foamed plastic

The first substrate and/or the primary layer of the first substrate may have a flexural modulus of at most about, and/or at least about, any of the following values: 4,000; 3,000; 2,500; 2,000; 1,900; 1,800; 1,700; 1,500; 1,200; 1,100; 1,000; 900; 800; 700; 600; and 500 psi (pounds/square inch). The flexural modulus (i.e., the tangent modulus of elasticity in bending) may be measured in accordance with ASTM D790-00 (Procedure A or B, depending on the nature of the material, as set forth in the ASTM test), which is incorporated herein in its entirety by reference. If the material is so flexible that it is difficult to run the above ASTM test procedure to calculate the flexural modulus (e.g., a material with a flexural modulus of less than about 1,000 psi), then the ASTM test may be modified by using a higher “Z” (i.e., rate of straining) and/or stacking several samples of the material together (taping the sample ends together) to run the test.

Any of first substrate, the primary layer 40, the supplemental layer 42, and the one or more additional layers 44, may comprise foamed plastic (e.g., any of the foamed plastic described herein) in at least about, and/or at most about, any of the following amounts: 50, 70, 90, and 99%, based on the weight of the first substrate, the primary layer, the supplemental layer, and the one or more additional layers, respectively.

Any of the first substrate, the supplemental layer 42, and the one or more additional layers 44 of the first substrate 18 may comprise thermosetting adhesive, for example, adhesive that is applied in the liquid state and subsequently cured. Thermosetting adhesive includes, for example, one or more selected from polyurethane adhesive (e.g., isocyanate-based polyurethane adhesive) and epoxy adhesive. Useful adhesives are taught in U. S. Pat. Nos. 5,582,906 and 5,670,211. The adhesives may be applied, for example, by spraying or coating.

Exemplary polyurethane adhesives (e.g., isocyanate-based polyurethane adhesive) are applied in the liquid state before curing and comprise as major ingredients isocyanates (e.g., toluene diisocyanate, diphenylmethanediisocyanate) and polyols (e.g., polyester polyols and polyether polyols), as well as other ingredients, for example, catalysts (e.g., organotin compounds and tertiary amines). The polyurethane adhesive may comprise prepolymer, in which a portion of the polyol is prereacted with an excess of the isocyanate to yield a prepolymer. The prepolymer may be subsequently reacted with the remaining portion of polyol to complete the curing reaction.

Any of the first substrate, the supplemental layer 42, and the one or more additional layers 44 of the first substrate 18 may comprise glass goods, for example, chopped glass fibers, glass mat, woven glass roving, and non-woven glass fabric. Any of first substrate, the supplemental layer 42, and the one or more additional layers 44, may comprise glass goods (e.g., any of the glass goods described herein) in at least about, and/or at most about, any of the following amounts: 50, 70, 90, and 99%, based on the weight of the first substrate, the supplemental layer, and the one or more additional layers, respectively. The layer comprising glass goods may have a basis weigh of, for example, at least about 50 grams per square meter and/or at most about 150 grams per square meter.

For example, a first substrate may comprise a supplemental layer comprising a thermosetting adhesive applied to the primary layer of the first substrate, such as a primary layer comprising polyurethane foam, to adhere an additional layer comprising glass goods to the primary layer. The film described above may be adhered to the first substrate, for example, directly adjacent to the additional layer comprising glass goods, to adhere the first substrate to a second substrate described herein. The film may substantially reduce the migration or “bleed through” of the adhesive of the supplemental layer (and/or the residual components of the cured adhesive) from the first substrate to the second substrate. The film may also help to reduce the tendency of the glass goods to protrude to cause an “orange peel” visual effect on the surface of the composite.

Any of the first substrate, the supplemental layer 42, and the one or more additional layers 44 of the first substrate 18 may comprise paperboard. Any of first substrate, the supplemental layer 42, and the one or more additional layers 44, may comprise paperboard in at least about, and/or at most about, any of the following amounts: 50, 70, 90, and 99%, based on the weight of the first substrate, the supplemental layer, and the one or more additional layers, respectively.

Any of the first substrate, the supplemental layer 42, and the one or more additional layers 44 of the first substrate 18 may comprise one or more non-glass fabrics selected from woven fabrics (e.g., tricot), knitted fabrics, non-woven fabrics (e.g., felt), and needle-punched textiles. A “non-glass fabric” is a fabric having less than 20 weight % glass as a component of the fabric. The non-glass fabrics may comprise fibers comprising one or more materials selected from: thermoplastic polymer, for example, one or more of nylon, polyester (e.g., polyethylene terephthalate (PET)), polyolefin (e.g., polyethylene and polypropylene), acrylic, and vinyl; cellulosic material (e.g., cellulosic material of the type used in making paper); rayon; and natural materials (e.g., cotton, wool, and silk). Useful non-glass fabrics are described, for example, in U.S. Pat. Nos. 5,591,289 and 4,851,283, each of which is incorporated herein in its entirety by reference.

Any of first substrate, the supplemental layer 42, and the one or more additional layers 44, may comprise non-glass fabric (e.g., any of the non-glass fabrics described herein) in at least about, and/or at most about, any of the following amounts: 50, 70, 90, and 99%, based on the weight of the first substrate, the supplemental layer, and the one or more additional layers, respectively.

Where the composite structure is adapted use in vehicle applications, for example, where the composite structure is an automotive headliner assembly, the first substrate may be the material of the composite structure adapted to be the farthest from the interior of the automobile in which the composite structure is installed.

The thickness of the primary layer of the first substrate may be greater than the thickness of the film. For example, the primary layer of the first substrate may have a thickness of at least about, and/or at most about, any of the following times the thickness of the film: 10, 30, 50, 100, and 150. Also by way of example, the primary layer of the first substrate may have a thickness of at least about, and/or at most about, any of the following: 0.5, 1, 3, 5, 7, 10, and 15 mm. The thickness of the first substrate may be sufficient to provide the physical characteristics desired for the end-use application. For example, the first substrate may have a thickness of at least about, and/or at most about, any of the following: 0.5, 1, 3, 5, 7, 10, and 15 mm. The thickness of any of the supplemental layer and/or any of the one or more additional layers of the first substrate may independently be any of the values set forth above with respect to the primary layer of the first substrate.

### Second Substrate of the Composite Structure

The film 10, 10′ may also be adhered to second substrate 20, 20′, 20″, for example, by having second substrate adhered to the second outer layer 14 of film 10, 10′. For example, second outer layer 14 may be directly adjacent to second substrate 20, 20′, 20″ of the composite structure.

The second substrate may comprise only one layer, for example, second substrate 20 comprises primary layer 36 (FIG. 1). The second substrate may comprise only two layers, for example, second substrate 20′ comprises primary layer 36 and supplemental layer 38 (FIG. 2). The second substrate may comprise three or more layers, for example, second substrate 20″ comprises primary layer 36, supplemental layer 38, and one or more additional layers 39 (FIG. 3).

The second outer layer 14 of film 10 may be adhered to the primary layer 36 and also be directly adjacent the primary layer 36 of the second substrate 20. (FIG. 1.) Alternatively, the second outer layer 14 of film 10 may be adhered to the primary layer 36 and not be directly adjacent the primary layer of the second substrate, for example, by having a supplemental layer 38 (FIG. 2) and/or one or more additional layers 39 (FIG. 3) between the first outer layer of the film and the primary layer of the first substrate. The primary layer 36 of the second substrate may be adhered to the second outer layer of film 10, yet have intervening layers such as the supplemental layer and/or the one or more additional layers between the primary layer of the second substrate and the second layer of film 10.

Any of the second substrate, the primary layer 36, the supplemental layer 38, and the one or more additional layers 39 of the second substrate may each comprise any of the types and amounts of materials (e.g., polyurethane, polyester, foamed polyurethane, reinforced plastics, foamed plastics, glass goods, paperboard, and non-glass fabrics) as set forth herein with respect to the first substrate, the primary layer 40, the supplementary layer 42, and the one or more additional layers 44.

For example, the primary layer 36 of the second substrate may comprise a non-glass fabric and supplemental layer 38 may comprise foamed plastic. For example, the second substrate may comprise a polyurethane foam-backed fabric. The foam may be selected to provide a soft hand feel for the second substrate.

In an embodiment where the primary layer 36 of the second substrate comprises non-glass fabric and the supplemental layer 38 of the second substrate comprises foamed plastic, the primary layer may be adhered to the supplemental layer, for example, by one or more of the following: adhesive bonding, melt bonding (e.g., thermal welding), and flame-lamination. For example, the primary layer 36 may be impregnated with resin to assist in bonding the non-glass fabric material to the foam material of supplemental layer 38. Useful adhesives for adhesive bonding may comprise one or more adhesives selected from acrylic adhesives and thermosetting adhesives, for example, any of those described herein, isocyanate-based polyurethane adhesives, and isocyanurate adhesives.

The primary layer 36 of the second substrate may be arranged to form an outer surface of the composite structure, for example, so that primary layer 36 of the second substrate may face toward the interior of an automobile driver/passenger compartment. The primary layer 36 of the second substrate may comprise non-glass fabric and may also form the outside surface of the composite structure. Where the composite structure is adapted use in vehicle applications, for example, where the composite structure is an automotive headliner assembly, the second substrate may be the material of the composite structure that is closest to the interior of the automobile in which the composite structure is installed. As such, the second substrate may comprise a facing material or coverstock.

The thickness of the primary layer of the second substrate may be greater than the thickness of the film. For example, the primary layer of the second substrate may have a thickness of at least about, and/or at most about, any of the following times the thickness of the film: 10, 30, 50, 100, and 150. Also by way of example, the primary layer of the second substrate may have a thickness of at least about, and/or at most about, any of the following: 0.5, 1, 3, 5, 7, 10, and 15 mm. The thickness of the second substrate may be sufficient to provide the physical characteristics desired for the end-use application. For example, the second substrate may have a thickness of at least about, and/or at most about, any of the following: 0.5, 1, 3, 5, 7, 10, and 15 mm. The thickness of any of the supplemental layer and/or any of the one or more additional layers of the second substrate may independently be any of the values set forth above with respect to the primary layer of the second substrate.

### Bond Strength of the Composite Structure

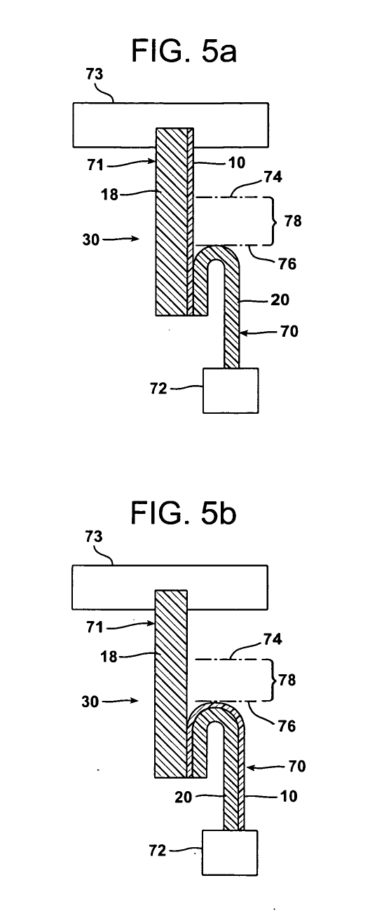

The ability of the film to bond or adhere the first substrate to the second substrate may be evaluated by the “creep test” described herein. All references either to the “creep distance” at a particular temperature or the “creep failure temperature” in this Application are measured according to the creep test procedures described herein. Five representative specimens of the composite structure to be tested are prepared to each have a size of 150 mm length and 25 mm width. The specimens are either separated at the interface between the film 10 and the second substrate 20 (FIG. 5a) or between the first substrate 18 and the film 10 (FIG. 5b), as desired for the test. The specimen portion 71 containing the first substrate 18 is secured, for example to frame 73, so that the specimen is in a vertical configuration with the separated portion 70 of the specimen hanging down. The separated portion 70 is placed in a 180° peel configuration with a 100 gram weight 72 secured to the end of the separated portion. (See FIGS. 5a and 5b.) The specimen having this configuration is positioned in an oven (not illustrated) having a controlled temperature environment.

To measure the creep distance, the specimen is positioned in the oven as described above for 24 hours at the temperature selected for the test. The selected temperature is maintained to be essentially constant for 24 hours. The distance that the separated portion peels or delaminates from the secured portion of the average of the five specimens over the 24 hour period at the controlled, selected temperature is the “creep distance” at the selected temperature.

FIG. 5a is representative of the configuration for creep testing, having composite structure specimen 30 positioned in the vertical configuration and separated between the film 10 and the second substrate 20 to form separated portion 70. Weight 72 having a mass of 100 grams is attached to the free end of the separated portion 70. The initial position 74 represents the position of the separated portion 70 before the test began. The final position 76 represents the position of the separated portion at the end of the 24 hour period. The distance 78 between the initial position 74 and the final position 76 is the creep distance.

FIG. 5b is representative of the configuration for creep testing, having composite structure specimen 30 separated between first substrate 18 and film 10 to form separated portion 80.

One or more embodiments of the composite structure may have a creep distance measured between the first substrate and the film, and/or between the film and the second substrate, of at most about any of the following: 12, 10, 8, 6, 4, 2, and 1 mm, where the temperature of the creep distance test is selected from any of the following: 60, 70, 80, 90, and 100° C.

To measure the creep failure temperature, the specimen is positioned in the oven as described above at an initial temperature of 40° C. After 30 minutes, the specimen is observed to determine whether the weighted portion of the specimen has completely separated from the vertical portion of the specimen. If not, then the temperature of the oven is raised by 10° C. and the observation is made again after 30 minutes. This process is repeated until the minimum set temperature is reached at which complete separation occurs. At the point the set temperature of the oven is recorded as the creep failure temperature.

One or more embodiments of the composite structure may have a creep failure temperature measured between the first substrate and the film, and/or between the film and the second substrate, of at least about any of the following: 80, 90, 100, 110, 120, 130, 140, and 150° C.

### Contoured Region of the Composite Structure

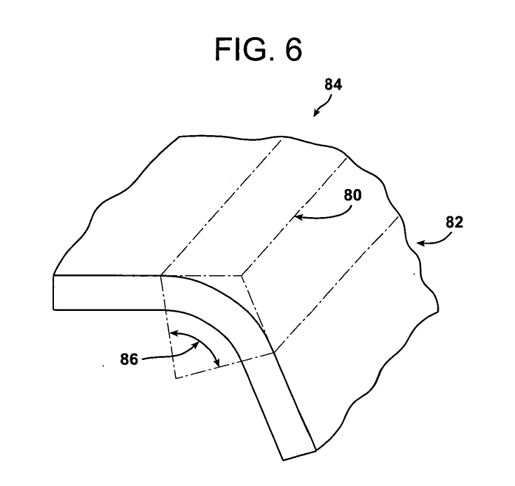

The composite structure may be shaped to have one or more contoured regions 80. Contoured regions may be formed in any region of the composite structure, for example, in the edge region 82 of shaped composite structure 84. (FIG. 6.) The composite structure may have one or more contoured regions having an inside bend angle 86 of at least about any of the following values: 45°, 55°, 65°, 75°, and 85°. The composite structure may have such one or more contoured regions as edge regions of the composite structure.

Making the Film

The film 10, 10′ may be manufactured by thermoplastic film-forming processes known in the art. The film may be prepared by extrusion or coextrusion utilizing, for example, a tubular trapped bubble film process or a flat film (i.e., cast film or slit die) process. The film may also be prepared by applying one or more layers by extrusion coating, adhesive lamination, extrusion lamination, solvent-borne coating, or by latex coating (e.g., spread out and dried on a substrate). A combination of these processes may also be employed. These processes are known to those of skill in the art.

### Making the Composite Structure

The composite structures 30, 30′, 30″ may be made by bonding or adhering the film to both the first substrate 18, 18′, and 18″ and the second substrate 20, 20′, 20″.

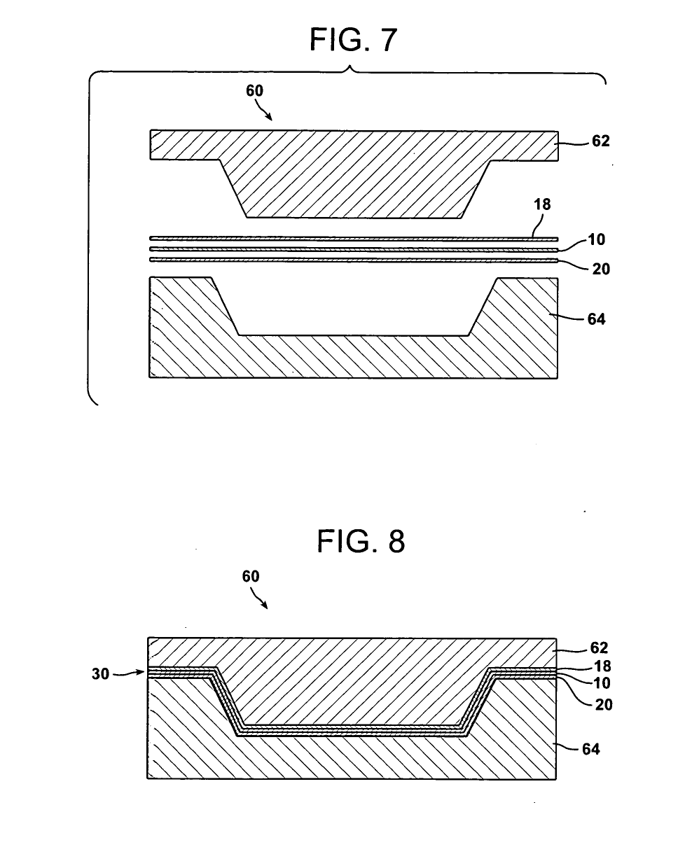

For example, the composite structure may be made by an in-mold technique using press forming mold 60 having upper and lower mold dies 62, 64. (FIGS. 7-8.) The component parts of the composite structure, for example, the first substrate 18, the second substrate 20, and the film 10, may be inserted into the press forming mold 60 and then formed and adhered together inside the mold. The first and second substrates 18, 20 and film 10 may be placed in the open mold between the upper mold die 62 and the lower mold die 64 in an arrangement where the film 10 is between the first and second substrates 18, 20. (FIG. 7.) For example, the first substrate (e.g., a sheet comprising reinforced plastic) may be placed between the open mold halves, then the film placed on the first substrate, then the second substrate (e.g., a sheet comprising polyurethane-foam backed fabric) may be placed on the film 10 to sandwich the film between the first and second substrates in a non-adhered state. The first substrate may be pre-molded (not shown) to a desired shape before the film and second substrate are applied.

The film may be pre-applied to the second substrate using, for example, a hot roll or lamination process. In such case, the unified film and second substrate may be placed directly on the first substrate in the molding process (not illustrated). Also by way of example, the first substrate, the second substrate, and the film may be pre-laminated together outside the mold (not illustrated) and then formed and adhered together inside the mold.

The press forming mold 60 may be pre-heated before closing. For example, the mold surfaces may be heated to a temperature of at least about, and/or at most about any of the following: 105, 110, 115, 120, 125, 135, 140, 150, 160, 170, and 180° C. The mold may be closed to compress the structure for at least about, and/or at most about, any of the following cycle times: 20 seconds, 30 seconds, 40 seconds, 60 seconds, and 90 seconds. Also, one or more of the first substrate, the second substrate, and the film may be pre-heated outside the mold before insertion into the mold. The mold 60 may be closed (FIG. 8) to form or shape the composite structure, for example, by softening the materials under heat and pressure so that the molding materials conform to the mold shape. During this time, the film 10 may be bonded or adhered to the first and second substrates 18, 20. After sufficient time has passed for effective bonding, the mold is opened and the molded composite structure is removed. The molded composite structure may then be further processed by trimming or other finishing work.

In this manner, the first and second substrates 18, 20 may be adhered and formed together at the same time to form the composite structure 30.

The steps of molding composite members to form a composite structure in the form of an automotive headliner are further described in U.S. Pat. Nos. 5,300,360; 6,808,576; 6,832,810; and 7,182,832, each of which is incorporated herein in its entirety by reference.

### Use of the Composite Structure

The composite structure may be a vehicle trim panel assembly. Examples of a vehicle trim assembly include interior trim components for a vehicle, for example, a headliner assembly (i.e., a headliner), a roof liner, a side liner (e.g., door liner), a visor, and a tray. The composite structure as a headliner assembly, for example, may be sized and shaped to line or conform to the interior roof in the passenger/driver compartment of a vehicle, so that the headliner assembly may be adhered or fastened by mechanical devices (clips or other fasteners) to the roof of a vehicle. The headliner improves the interior appearance of the vehicle, while also providing some padding and sound reduction or dampening enhancements. Examples of vehicles include any of automobiles, trucks, recreational vehicles, sport utility vehicles, airplanes, jets, trains, and boats. Composite structure may be a structural or finishing component for use in furniture, office cubicles, partitions, housing, furniture, and buildings.

Although the composite structure may sometimes be described herein in the context of an automobile headliner assembly, the term “composite structure” should be interpreted broadly, not being limited to an automobile headliner assembly.

The following examples are presented for the purpose of further illustrating and explaining the present invention and are not to be taken as limiting in any regard. Unless otherwise indicated, all parts and percentages are by weight.

### EXAMPLES

### Films

The following films were made as examples of films that are useful to make one or more embodiments of the composite structure of the present invention. The following material abbreviations are used with respect to the films:

EAA1 is an antiblock master batch of silica in ethylene/acrylic acid copolymer available from Ampacet Corporation under the 101611 trade name.

EAA2 is an ethylene/acrylic acid copolymer available from Dupont Corporation under the Nucrel 30705 trade name and believed to have an acrylic acid comonomer content of about 7 wt. % and a melting point of about 107° C.

LLDPE is maleic anhydride-modified linear low density polyethylene available from Equistar, Division of Lyondell Corporation under the PX3236 trade name and believed to have a melting point of about 125° C.

EVA is an ethylene/vinyl acetate copolymer available from Flint Hills Resources LLP under the PE1335 trade name and believed to have a vinyl acetate comonomer content of about 3.3 wt. % and a melting point of about 105° C.

PA6 is a nylon-6 available from BASF Corporation under the Ultramid B40 trade name believed to have a melting point of about 220° C.

PA6/6,9 is a nylon-6/6,9 available from EMS-Grivory Corporation under the Grilon BM 13 SBG trade name and believed to have a melting point of about 130 to about 137° C.

PA6/6,6 is a nylon-6/6,6 available from BASF Corporation under the Ultramid B40 trade name believed to have a melting point of about 196° C.

Ionomer1 is an ionomer comprising zinc-neutralized ethylene/methacrylic acid copolymer available from Dupont Corporation under the Surlyn 1652 trade name.

Ionomer2 is an ionomer comprising zinc-neutralized ethylene/methacrylic acid copolymer available from Dupont Corporation under the Surlyn 1702-1 trade name and believed to have a methacrylic acid comonomer content of about 9 wt. % and a melting point of about 100° C.

Film 1 was coextruded as a 7 layer film having a thickness of 1.5 mils and the following structure:
A/B/C/D/C/B/A
   where A is 97% Ionomer1 and 3% EAA1 (10%);
B is Ionomer1 (15%);
C is 60% LLDPE and 40% EVA (21.5%); and
D is PA6 (7%).
   The layer thicknesses as a percentage of the total thickness are set forth in parentheses above. A Film 1 was also made having a 2 mil total thickness.

Film 2 was coextruded as a 7 layer film having a thickness of 1.5 mils and the following structure:
A/B/C/D/C/E/F
   where A is 97% Ionomer1 and 3% EAA1 (10%);
B is EVA (15%);
C is 60% LLDPE and 40% EVA (23.5%);
D is PA6 (7%);
E is LLDPE (11%); and
F is 97% PA6/6,9 and 3% EAA1 (10%).
   The layer thicknesses as a percentage of the total thickness are set forth in parentheses above. A Film 2 was also made having a 2 mil total thickness.

Film 3 was coextruded as a 7 layer film having a: thickness of 1.5 mils and the following structure:
A/B/C/D/C/B/A
   where A is 97% Ionomer2 and 3% EAA1 (10%);
B is Ionomer2 (15%);
C is 60% LLDPE and 40% EVA (21.5%); and
D is PA6/6,6 (7%).
   The layer thicknesses as a percentage of the total thickness are set forth in parentheses above.

Film 4 was made as a 7 layer film having a thickness of 1.5 mils and the following structure:
A/B/C/D/C/B/A
   where A is 58% Ionomer2, 39% Ionomer1, and 3% EAA1 (10%);
B is Ionomer1 (15%);
C is 60% LLDPE and 40% EVA (21.5%); and
D is PA6/6,6 (7%).
   The layer thicknesses as a percentage of the total thickness are set forth in parentheses above.

Film 5 was made as a 7 layer film having a thickness of 1.5 mils and the following structure:
A/B/C/D/C/E/F
   where A is 97% Ionomer2 and 3% EAA1 (10%);
B is EVA (15%);
C is 60% LLDPE and 40% EVA (23.5%);
D is PA6/6,6 (7%); and
E is LLDPE (11%); and
F is 97% PA6/6,9 and 3% EAA1 (10%).
   The layer thicknesses as a percentage of the total thickness are set forth in parentheses above.

Film 6 was made as a 7 layer film having a thickness of 1.5 mils and the following structure:
A/B/C/D/C/E/F
   where A is 58% Ionomer2, 39% Ionomer1, and 3% EAA1 (10%);
B is EVA (15%);
C is 60% LLDPE and 40% EVA (23.5%);
D is PA6/6,6 (7%);
E is LLDPE (11%); and
F is 97% PA6/6,9 and 3% EAA1 (10%).
   The layer thicknesses as a percentage of the total thickness are set forth in parentheses above.

### Example 1

A composite structure (Example 1) was made according to an embodiment of the present invention having the following layers:
A/B/C/D/C/E/A
   where: A was a polyester nonwoven fabric;
B was Film 1 as set forth above;
C was chopped strand glass fibers;
D was an ether-based polyurethane foam having a density of about 2 pounds/cubic foot and a thickness of about 7 mm, which was roll-coated on each side with a thermosetting polyurethane liquid adhesive and a catalyst spray both available from Forbo Adhesives LLC under the 2U010 and 22014 trade names, respectively; and
E was a 1.5 mil film available from Dow Chemical Company under the Integral 906A trade name, and believed to comprise a core layer of linear low density polyethylene and outer layers of ethylene/acrylic acid copolymer.

The above layers were molded in a contoured mold having a temperature of about 350° F. (177° C.) for about 40 seconds to produce a composite structure.

A comparative structure (Comparative 1) was made similar to the Example 1 structure above and under the same conditions, except that for the Comparative 1 structure the B layer was a 7-layer film having the following structure:
a/b/c/d/c/b/a
   where “a” is 97% EAA2 and 3% EAA1 (7%);
“b” is EAA2 (13%);
“c” is 60% LLDPE and 40% EVA (26.5%); and
“d” is PA6 (7%).
   The layer thicknesses as a percentage of the total thickness are set forth in parentheses above.

The Example 1 structure yielded excellent bonding strength within the composite including in the contoured regions of the structure, although there were also some areas in the flat region of the structure where air pockets existed within the composite structure such that bonding was unsatisfactory in those areas.

In comparison, the Comparative 1 structure displayed unsatisfactory bonding strength over the breadth of the structure. It was surprising and unexpected that the Example 1 structure displayed excellent bonding strength within the composite, whereas the Comparative 1 structure displayed unsatisfactory bonding strength within the composite, where the difference between the two structures was the outer layers of the films for the B layer of the structure, the Example 1structure using film with an outer layer comprising ionomer and the Comparative 1 structure using film an outer layer comprising ethylene/acrylic acid copolymer, as set forth above.

### Examples 2 and 3

A composite structure (Example 2) was made according to an embodiment of the present invention having the following layers:
A/B/C/D/C/E/A
   where: A was a polyester nonwoven fabric;
B was Film 3 as set forth above;
C was chopped strand glass fibers;
D was an ether-based polyurethane foam having a density of about 2 pounds/cubic foot and a thickness of about 7 mm, which was roll-coated on each side with a thermosetting polyurethane liquid adhesive and a catalyst spray both available from Forbo Adhesives LLC under the 2U010 and 22014 trade names, respectively; and
E was a 1.5 mil film available from Dow Chemical Company under the Integral 906A trade name, and believed to comprise a core layer of linear low density polyethylene and outer layers of ethylene/acrylic acid copolymer.

The above layers were molded for about 30 seconds in a contoured mold having a temperature of about 345° F. on the upper mold die and about 340° F. on the lower mold die to produce a composite structure.

A composite structure (Example 3) was made as an embodiment of the present invention with the same structure and under the same conditions as Example 2, except that the B layer was Film 4 as set forth above.

Both the Example 2 and Example 3 structures yielded excellent bonding strength within the composite including in the contoured regions of the structure. There were no air pockets or areas of delamination within the composite structure.

The Example 3 structure was further processed to produce an automotive headliner composite structure by compression molding a polyrurethane foam-backed coverstock material layer to the Example 3 structure using an intermediate E layer as set forth above (Dow Integral 906A). The mold temperature was from about 225° F. to about 275° F.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

What is claimed is:

1. A composite structure comprising:
a film having a given thickness and comprising:
a first outer layer comprising ionomer;
a second outer layer comprising one or more polymers selected from a) ionomer, b) polyamide having a melting point of at most about 200° C., c) amorphous polyamide, and d) polyester; and
an intermediate layer between the first and second outer layers, the intermediate layer comprising one or more polyamides;
a first substrate adhered to the first outer layer of the film, the first substrate comprising a primary layer having a thickness greater than the thickness of the film and comprising one or more polymers selected from polyurethane and polyester, and a second substrate adhered to the second outer layer of the film, the second substrate having a thickness greater than the thickness of the film.

2. The composite structure of claim 1 wherein the intermediate layer of the film has a thickness of at most about 15% of the total thickness of the film.

3. The composite of claim 1 wherein the intermediate layer has a melting point of at least about 190° C.

4. The composite structure of claim 1 wherein the second outer layer of the film comprises ionomer.

5. The composite structure of claim 4 wherein the second outer layer comprises ionomer different from the ionomer comprised by the first outer layer.

6. The composite structure of claim 1 wherein the second outer layer of the film comprises polyamide having a melting point of at most about 200° C.

7. The composite structure of claim 1 wherein the second outer layer of the film comprises amorphous polyamide.

8. The composite structure of claim 1 wherein the second outer layer of the film comprises polyester.

9. The composite structure of claim 1 wherein the primary layer of the first substrate comprises polyurethane.

10. The composite structure of claim 1 wherein the primary layer of the first substrate comprises polyester.

11. The composite structure of claim 1 wherein the primary layer of the first substrate comprises reinforced plastic.

12. The composite structure of claim 1 wherein one of the outer layers of the film is directly adjacent to the primary layer of the first substrate.

13. The composite structure of claim 1 wherein the first substrate comprises a supplemental layer comprising one or more glass goods.

14. The composite structure of claim 1 wherein the first substrate comprises a supplemental layer comprising one or more non-glass fabrics.

15. The composite structure of claim 1 wherein the first substrate comprises thermosetting adhesive.

16. The composite structure of claim 15 wherein the thermosetting adhesive is cured thermosetting adhesive.

17. The composite structure of claim 1 wherein the first substrate comprises an isocyanate-based polyurethane adhesive.

18. The composite structure of claim 1 wherein the second substrate comprises a primary layer comprising one or more materials selected from reinforced plastic, foamed plastic, glass goods, paperboard, and non-glass fabric.

19. The composite structure of claim 18 wherein the primary layer of the second substrate is an outer layer of the second substrate.

20. The composite structure of claim 1 wherein the creep distance at a temperature of 80° C. between the first substrate and the film is at most about 10 mm.

21. The composite structure of claim 1 wherein the creep failure temperature between the first substrate and the film is at least about 100° C.

22. The composite structure of claim 1 having one or more contoured regions each having an inside bend angle of at least about 45° C.

23. The composite structure of claim 1 wherein the composite structure is an automotive headliner assembly.
